(19) United States
(12) Patent Application Publication
(10) Pub. No.: US 2005/0029283 A1
(43) Pub. Date: Feb. 10, 2005

(54) Refrigerator vending device

(76) Inventor: Tim Pedigo, Springfield, MO (US)

Correspondence Address: LATHROP & GAGE LC, 1845 S. NATIONAL, P.O. BOX 4288, SPRINGFIELD, MO, 65101, US

(21) Appl. No.: 10/638,026

(22) Filed: Aug. 8, 2003

(51) Int. Cl. B65G 59/00; B65H 3/30; G07F 11/16

(52) U.S. Cl. 221/289

(57) ABSTRACT

A coin operated beverage dispensing device for use in a refrigerator.

### FIELD OF INVENTION

The present invention relates to a beverage dispensing device for use in a refrigerator, or similar cooling apparatus.

### BACKGROUND OF THE INVENTION

The invention relates to a coin operated beverage dispensing device which is intended to be kept in a refrigerator or similar cooling device. In particular, the invention has applications for small businesses and residences. Businesses having too few employees to justify the space and cost of a full-sized beverage dispensing machine often resort to storing beverages in a community refrigerator. Reliance on the “honor” system for workers to pay for sodas from a refrigerator often leaves the business owner providing free drinks to the employees. What is needed is a coin-operated beverage dispenser that can be positioned in a conventional refrigerator

Another need for such a beverage dispenser is for residential use. The inventive device can be modified to accept coins, of any denomination, or tokens. A parent attempting to control their children's intake of carbonated beverages, for example, can allocate coins, or tokens, for the acceptable number of beverages in a given time period. Further, a residential beverage dispenser for the refrigerator can be used to segregate alcoholic beverages from other drinks. The adults can maintain tokens, accepted only by the beverage dispenser, which will eliminate the possibility of minors taking the alcoholic beverages.

### SUMMARY OF THE INVENTION

The inventive device is directed towards a coin operated beverage dispenser in residences. For the purposes of this patent, it should be understood that the all references to coins and coin operation included all coin combinations, and includes tokens or similar devices used for accessing vending apparatuses.

Generally, the device includes a housing of sufficient dimensions to store a predetermined quantity and type of beverages. For example, a desirable size for the housing would be sufficient to hold twelve, twelve-ounce beverage cans, and which fits in a standard sized household refrigerator.

Within the housing, a series of ramps urge the beverage containers to a serving opening. The beverage cans are mechanically blocked from the serving opening by a first dispensing paddle or second, spaced apart dispensing paddle. The two dispensing paddles are spaced apart approximately the diameter of a single beverage and are one hundred and eighty degrees opposed. Therefore, when one paddle is oriented in a downward position, effectively blocking a beverage container from the serving opening, the other paddle is in an upright position. As the blocking paddle moves upward allowing the beverage to move down a provided incline, the second paddle rotates downward to block the next sequential beverage container.

The two dispensing paddles are mounted to a shaft which is connected to a coin-operated receiver configured to rotate one hundred and eighty degrees with every insertion of the appropriate coin combination. As the coin receiver rotates, coins are transferred to a storage slot. Each rotation of coin receiver rotates the dispensing paddles one half of a full turn, which allows a single beverage to be dispensed.

The instant invention is easy and inexpensive to manufacture, and uses commercially available parts.

### BRIEF DESCRIPTION OF THE DRAWINGS

FIG. 1 is a perspective view of an embodiment of the inventive device as it would be used.

FIG. 2 is a second perspective view of an embodiment of the inventive device.

FIG. 3 is a cut away view taken along line 3-3 of FIG. 2.

FIG. 4 is a partial skeletal view of an embodiment of the inventive device.

FIG. 5 is a segment view of a portion of the inventive device.

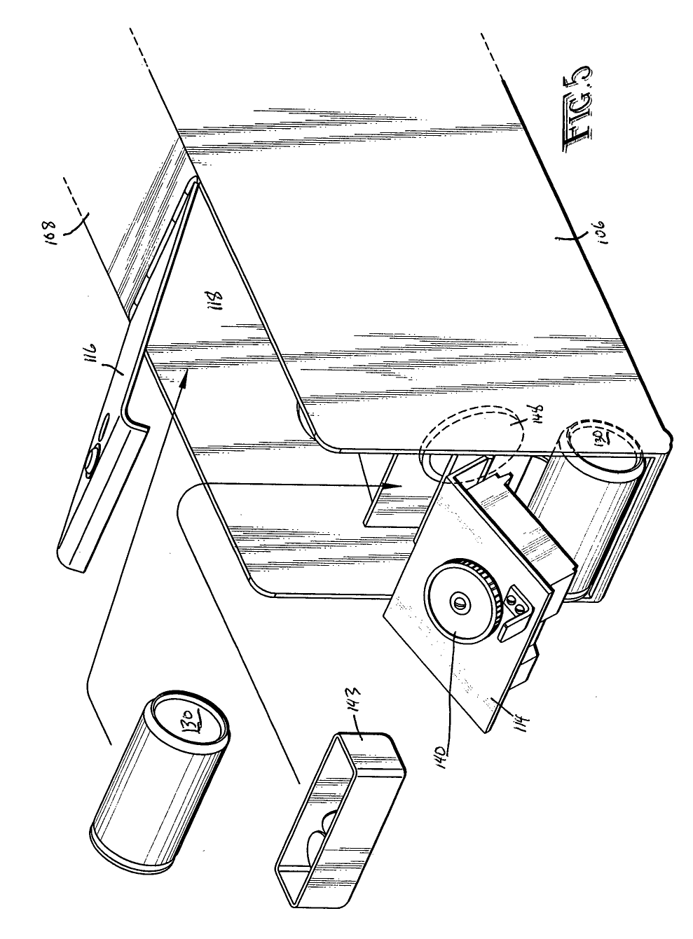

### DETAILED DESCRIPTION OF THE INVENTION

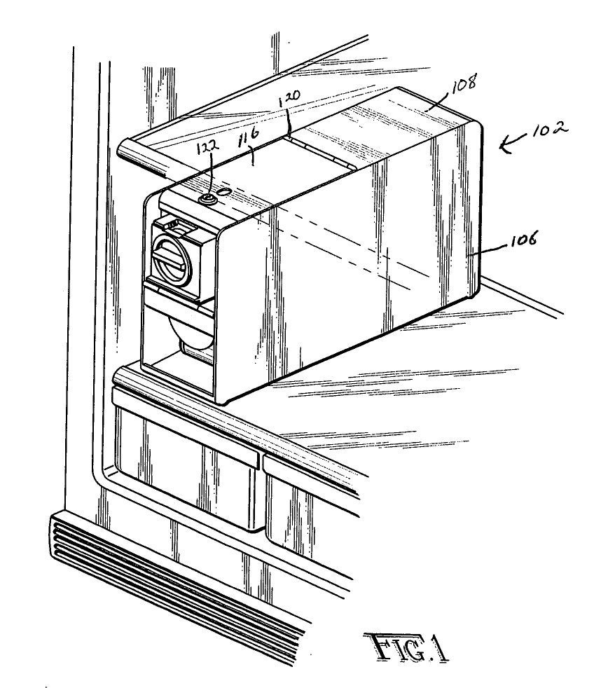

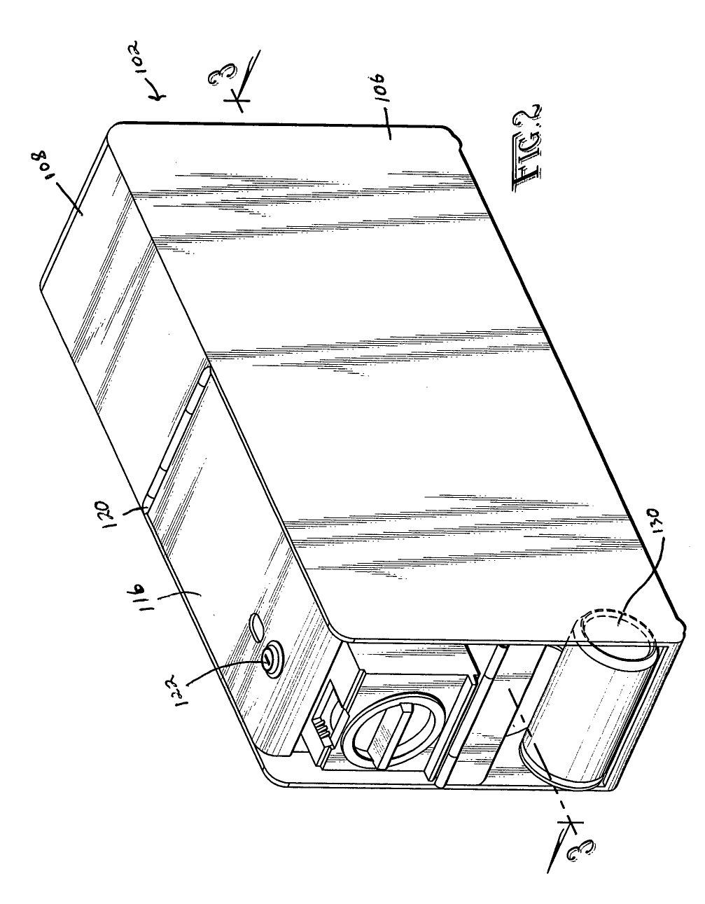

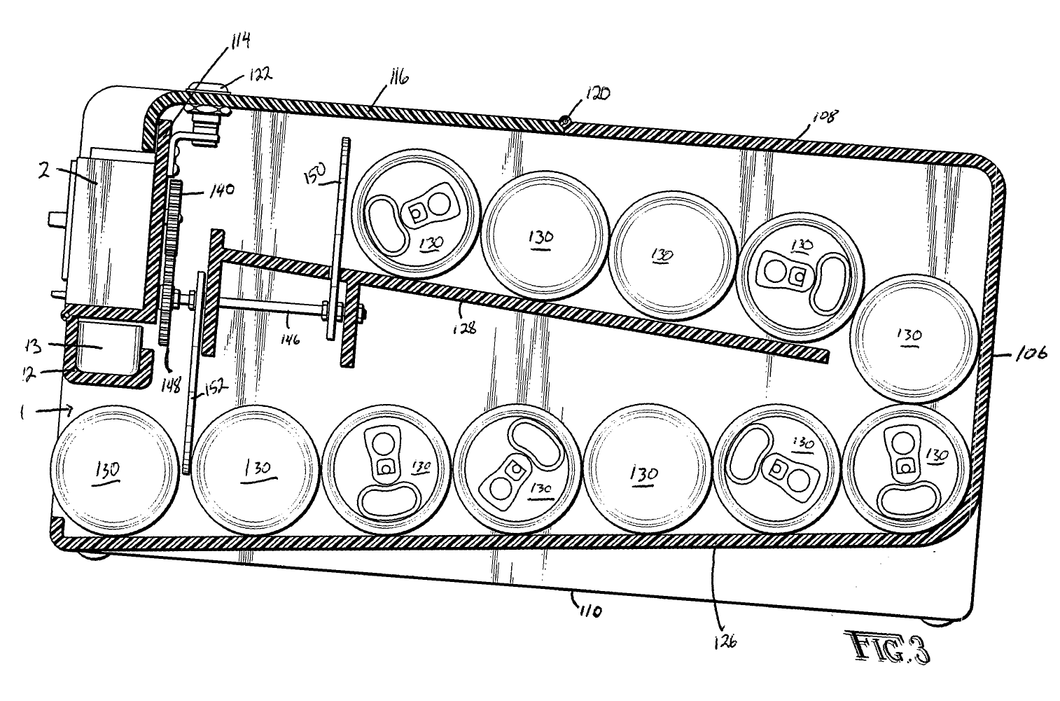

Referring now generally to FIGS. 1, 2 and 3, a refrigerator vending device in accordance with the present invention is shown generally at 102. The vending device 102 comprises a housing 104 having two opposed sides 106, an upper wall 108, a lower wall 110, a rear wall 112 and a dispensing wall 114, which combine to define a beverage storage space 118. It is preferred that the housing 104 is manufactured of clear, or transparent rigid material, such as plastic, which is durable and allows users to view the contents of the device. The housing 104 is preferably configured to fit between the racks of a standard size residential refrigerator as shown in FIG. 1. In one embodiment, the opposed walls 106 are fixed at a width of between five and one half and six and one half inches which accommodates twelve ounce beverage cans 130. To house approximately twelve beverage cans 130, the housing 104 is preferably between eight and eleven inches tall and between seventeen and twenty inches long. These ranges of dimensions allow the device to easily fit within the racks of a residential refrigerator and accommodate approximately twelve beverages. It should be understood that that dimensions of the housing 104 can vary greatly for different applications.

A filler door 116 is preferably provided in the upper wall 108 of the housing 104 for access to the beverage storage space 118. Beverages 130 may thus be loaded in the beverage storage space 118 of the vending device 102. The filler door 116 is provided with a hinge 120 or can be configured to be fully removed from the housing 104. A locking mechanism 122 should be provided to secure the filler door 116 to prevent users from taking beverages without paying or without permission.

A dispensing opening 124 is provided in the dispensing wall 114 substantially adjacent to the housing bottom 110. The dispensing opening 124 is of sufficient dimension to allow the beverage container 130 to be dispensed. At least one ramp 126 is fixed between the housing sides 106 and is positioned to have a downward slope from the housing back wall 112 to a position adjacent the dispensing opening 124.

In order to increase the storage area for beverage containers, an upper ramp 128 and lower ramp 126 are provided to store beverage containers 130 and direct them to the dispensing opening 124. The beverage containers 130 are placed in the beverage storage space 118 sequentially along the lower ramp 126 and the upper ramp 128. The upper ramp 128 is angled generally downward from the dispensing wall 114 toward the back wall 112, terminating at a point above the lower ramp 126 so that a beverage container 130 will roll from the upper ramp 128 downward onto the lower ramp 126 by gravitational force. Both the upper ramp 128 and lower ramp 126 are preferably mounted to the opposing sides 106 with adhesive, or they may be formed integrally with the housing sides 106.

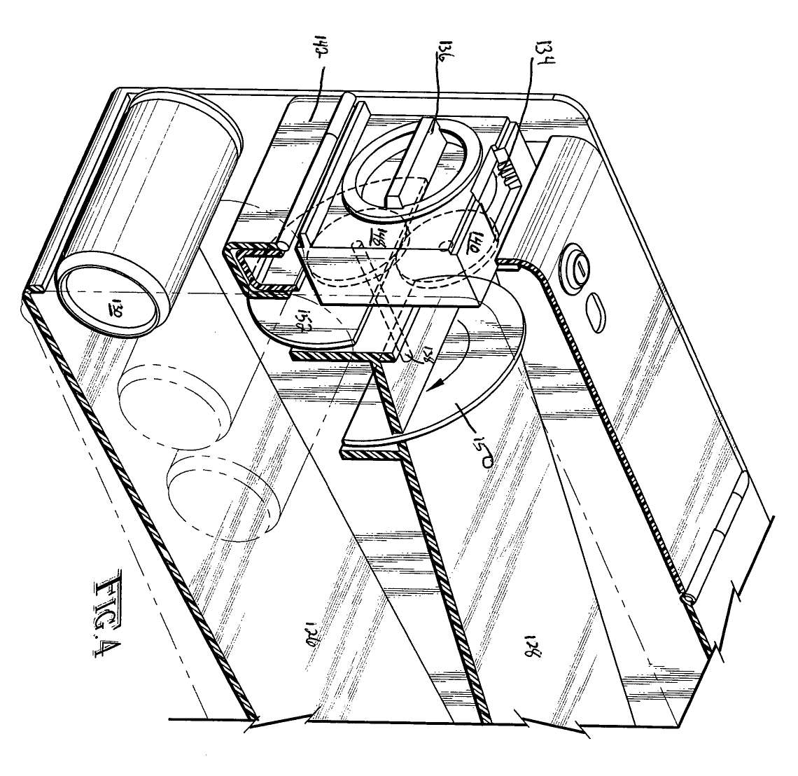

A vending mechanism 132 is attached to the dispensing wall 114 adjacent the dispensing opening 124. It is preferred that the vending mechanism 132 is coin, or token, operated and is of the mechanical rotational variety. As shown in FIG. 4, available rotational vending mechanisms are provided with coin receiving slots 134, a knob 136, a spindle 138 and a gear 140 attached to the spindle 138. When a coin, or token, is placed into the coin receiving slots 134 and the knob 136 is actuated, the spindle 138 and attached gear 140 are also rotated. For the instant invention, the vending mechanism 132 must rotate three hundred and sixty degrees for each dispensing operation. A coin receptacle 142 is provided in the dispensing wall 114 adjacent the vending mechanism 132.

A shaft 146 is connected to a mating gear 148. The mating gear 148 is in a mating relationship with gear 140 of the vending mechanism 132. The shaft 146 extends generally rearward toward the back wall 112 of the housing 104. A first dispensing paddle 150 is attached to the shaft 146 at its proximal end nearest the dispensing wall 114, and a second dispensing paddle 152 is spaced apart from the first dispensing paddle 150, and attached to a distal end of the shaft 146 in an orientation substantially one hundred and eighty degrees from the orientation of the first dispensing paddle 150. The first dispensing paddle 150 and the second dispensing paddle 152 must be spaced apart approximately the width of the beverage container which is intended to be dispensed.

The second dispensing paddle 152 blocks a beverage container 130 from moving from the bottom ramp 126 to the dispensing opening 124. Upon actuation of the knob 136 approximately 180 degrees, the second dispensing paddle 152 moves from a downward orientation to an upward orientation allowing the beverage containers 130 to move generally downward along the bottom ramp 126 and generally forward toward the dispensing opening 124. Concurrently, the first dispensing paddle 150 moves from a generally upward orientation to a generally downward orientation blocking the row of beverage containers 130. Upon another rotation of the knob 136, the shaft 146 is rotated another approximately 180 degrees and the second dispensing paddle 152 moves generally downward between the first and second beverage containers 130 in the row and the first dispensing paddle 150 moves into a generally upward orientation allowing the first positioned beverage container 130 to move to the dispensing opening 124. The first dispensing paddle 150 and second dispensing paddle 152 are each rotated approximately 360 degrees with each full rotation of the knob 136.

While the invention has been particularly shown and described with reference to the preferred embodiments thereof, it is well understood by those skilled in the art that various changes and modifications can be made without departing from the spirit and scope of the invention.

1. A vending apparatus for use in a refrigerator, the refrigerator having vertically spaced racks defining storage space therebetween, the apparatus comprising:
(a) a housing having a beverage container storage space defined by two opposed sides, an upper wall, a lower wall, a back wall and a dispensing wall, the dispensing wall further comprising a dispensing opening; the housing being operably sized and configured to be mounted between the racks of the refrigerator;
(b) a vending mechanism attached to the dispensing wall adjacent the dispensing opening;
(c) at least one ramp for gravitationally moving beverage containers, the ramp mounted between the opposed sides sloping generally downward from the back wall to the dispensing wall;
(d) a shaft connected to and actuated by the vending mechanism, the shaft extending generally toward the back wall;
(e) a first dispensing paddle attached to the shaft and a second dispensing paddle spaced apart from the first dispensing paddle and attached to the shaft in an orientation substantially one hundred and eighty degrees from the orientation of the first dispensing paddle; and wherein
the second dispensing paddle blocks a beverage container from moving from the ramp to the dispensing opening and upon approximately 180 degrees of rotation of the shaft, the second paddle moves from a downward orientation to an upward orientation allowing the beverage containers to move forward toward the dispensing opening, the first dispensing paddle moves from an upward orientation to a generally downward orientation blocking the row of beverage containers, upon another 180 degrees of shaft rotation, the second dispensing paddle moves downward between the first and second beverage containers in the row and the first dispensing paddle moves upward allowing the first beverage can to move to the dispensing opening.

2. The refrigerator vending device of claim 1 wherein the ramp is spaced rearward from the dispensing opening at least the with of a single beverage container to be dispensed;

3. The refrigerator vending device of claim 1 further comprising a coin receptacle positioned adjacent the vending mechanism.

4. The refrigerator vending device of claim 1 further comprising a filler door provided in the upper wall of the housing.

5. The refrigerator vending device of claim 4 further comprising a locking mechanism on the filler door.

6. The refrigerator vending device of claim 1 further wherein the at least one ramp comprises an upper ramp sloping generally downward from a point adjacent the dispensing wall to a point adjacent the back wall and a bottom ramp sloping generally downward from the back wall to a point adjacent the dispensing opening.

7. A refrigerator vending device comprising:
(a) a housing defining a beverage storage space;
(b) at least one ramp positioned within the beverage storage space;
(c) a vending mechanism attachable to the housing, the vending mechanism further rotationally connected to a shaft oriented generally into the beverage storage space and generally above the at least one ramp;
(d) a first dispensing paddle and a spaced apart second dispensing paddle both fixed to the shaft; and wherein
a plurality of beverage containers placed in sequence on the ramp are dispensed by rotationally actuating the vending mechanism thereby rotating the connected shaft and first dispensing paddle and second dispensing paddle and wherein the first dispensing paddle selectively blocks the firstmost beverage container and the second dispensing paddle selectively blocks the remaining beverage containers positioned on the ramp.
